(19) United States
(12) Patent Application Publication
(10) Pub. No.: US 2024/0242540 A1
(43) Pub. Date: Jul. 18, 2024

(54) ACTION RECOGNITION METHOD AND DEVICE, MODEL TRAINING METHOD AND DEVICE, AND ELECTRONIC DEVICE

(71) Applicant: BOE TECHNOLOGY GROUP CO., LTD., Beijing (CN)

(72) Inventors: Xianbin LIU, Beijing (CN); Fanhao KONG, Beijing (CN); Zhanfu AN, Beijing (CN); Zeyu SHANGGUAN, Beijing (CN)

(73) Assignee: BOE TECHNOLOGY GROUP CO., LTD., Beijing (CN)

(21) Appl. No.: 18/562,336

(22) PCT Filed: Jan. 4, 2023
(86) PCT No.: PCT/CN2023/070431

§ 371 Date: Nov. 20, 2023

(30) Foreign Application Priority Data
Jan. 21, 2022 (CN) 202210072157.X

(51) Int. Cl. G06V 40/20; G06V 10/26; G06V 10/74; G06V 10/764; G06V 10/774; G06V 20/40

(52) U.S. Cl. CPC G06V 40/20; G06V 10/267; G06V 10/273; G06V 10/761; G06V 10/764; G06V 10/774; G06V 20/41

(57) ABSTRACT

An action recognition method includes: an electronic device sampling a plurality of image frames of a video to be recognized, and according to the plurality of image frames and a pre-trained self-attention model, determining a probability distribution of the video to be recognized being similar to a plurality of action categories; further, based on the probability distribution of the video to be recognized being similar to the plurality of action categories, the electronic device determining, from the plurality of action categories, an action category having a probability greater than or equal to a preset threshold as a target action category corresponding to the video to be recognized.

### CROSS-REFERENCE TO RELATED APPLICATIONS

This application is a national phase entry under 35 USC 371 of International Patent Application No. PCT/CN2023/070431, filed on Jan. 4, 2023, which claims priority to Chinese Patent Application No. 202210072157.X, filed on Jan. 21, 2022, which are incorporated herein by reference in their entirety.

### TECHNICAL FIELD

The present disclosure relates to the field of computer technologies, and in particular, to an action recognition method and device, a model training method and device, and an electronic device.

### BACKGROUND

In human-computer interaction, video understanding, security protection, and other scenarios, an action recognition method based on a convolutional neural network (CNN) is usually used to recognize various behavior and action in videos. Specifically, the electronic device uses CNN to detect images in the video to recognize and obtain human target point detection results and preliminary action recognition results in the images, and train and obtain the action recognition neural network according to the human target point detection results and the action recognition results. Further, the electronic device identifies the behavior and action in the above images according to the trained action recognition neural network.

However, in a detection process of the above-mentioned action recognition method, a large number of convolution operations need to be performed based on CNN, especially in a case where the video is relatively long, using the CNN convolution operations requires large computing resources, which affects performance of the device.

### SUMMARY

In an aspect, an action recognition method is provided. The action recognition method includes: obtaining a plurality of image frames of a video to be recognized; determining a probability distribution of the video to be recognized being similar to a plurality of action categories according to the plurality of image frames and a pre-trained self-attention model, wherein the self-attention model is used to calculate similarity between an image feature sequence and the plurality of action categories through a self-attention mechanism, the image feature sequence is obtained in time dimension or spatial dimension based on the plurality of image frames, and the probability distribution includes a probability that the video to be recognized is similar to each action category in the action categories; and determining a target action category corresponding to the video to be recognized based on the probability distribution of the video to be recognized being similar to the plurality of action categories, wherein a probability that the video to be recognized is similar to the target action category is greater than or equal to a preset threshold.

In some embodiments, the self-attention model includes a self-attention coding layer and a classification layer, the self-attention coding layer is used to calculate a similarity feature of the image feature sequence relative to the plurality of action categories, and the classification layer is used to calculate the probability distribution corresponding to the similarity feature. Determining the probability distribution of the video to be recognized being similar to the plurality of action categories according to the plurality of image frames and the pre-trained self-attention model, includes: determining a target similarity feature of the video to be recognized relative to the plurality of action categories according to the plurality of image frames and the self-attention coding layer, the target similarity feature being used to characterize similarity between the video to be recognized and each action category; and inputting the target similarity feature to the classification layer to obtain the probability distribution of the video to be recognized being similar to the plurality of action categories.

In some embodiments, before determining the target similarity feature of the video to be recognized relative to the plurality of action categories according to the plurality of image frames and the self-attention coding layer, the method further includes: segmenting each image frame in the plurality of image frames to obtain a plurality of sampling sub-images. In this case, determining the target similarity feature of the video to be recognized relative to the plurality of action categories according to the plurality of image frames and the self-attention coding layer, includes: determining at least one sequence feature of the video to be recognized according to the plurality of sampling sub-images and the self-attention coding layer; and determining the target similarity feature according to the at least one sequence feature of the video to be recognized. The at least one sequence feature includes a time sequence feature, or both the time sequence feature and a space sequence feature. The time sequence feature is used to characterize similarity between the video to be recognized and the plurality of action categories in the time dimension, and the space sequence feature is used to characterize similarity between the video to be recognized and the plurality of action categories in the spatial dimension.

In some embodiments, determining the time sequence feature of the video to be recognized, includes: determining at least one time sampling sequence from the plurality of sampling sub-images, each time sampling sequence including sampling sub-images of all image frames located in same positions; determining a time sequence sub-feature of each time sampling sequence according to each time sampling sequence and the self-attention coding layer, the time sequence sub-feature being used to characterize similarity between each time sampling sequence and the plurality of action categories; and determining the time sequence feature of the video to be recognized according to a time sequence sub-feature of the at least one time sampling sequence.

In some embodiments, determining the time sequence sub-feature of each time sampling sequence according to each time sampling sequence and the self-attention coding layer, includes: determining a plurality of first image input features and a category input feature, wherein each first image input feature is obtained by performing position encoding merging on image features of sampling sub-images included in a first time sampling sequence, the first time sampling sequence is any of the at least one time sampling sequence, the category input feature is obtained by performing position encoding merging on a category feature, and the category feature is used to characterize the plurality of action categories; and inputting the plurality of first image input features and the category input feature into the self-attention coding layer, and determining an output feature output by the self-attention coding layer corresponding to the category input feature as a time sequence sub-feature of the first time sampling sequence.

In some embodiments, determining the space sequence feature of the video to be recognized, includes: determining at least one space sampling sequence from the plurality of sampling sub-images, each space sampling sequence including sampling sub-images of an image frame; determining a space sequence sub-feature of each space sampling sequence according to each space sampling sequence and the self-attention coding layer, the space sequence sub-feature being used to characterize similarity between each space sampling sequence and the plurality of action categories; and determining the space sequence feature of the video to be recognized according to a space sequence sub-feature of the at least one space sampling sequence.

In some embodiments, determining the at least one space sampling sequence from the plurality of sampling sub-images, includes: for a first image frame, determining a preset number of target sampling sub-images located in preset positions from sampling sub-images included in the first image frame, and determining the target sampling sub-images as a space sampling sequence corresponding to the first image frame; the first image frame being any of the plurality of image frames.

In some embodiments, determining the space sequence sub-feature of each space sampling sequence according to each space sampling sequence and the self-attention coding layer, includes: determining a plurality of second image input features and a category input feature, wherein each second image input feature is obtained by performing position encoding merging on image features of sampling sub-images included in a first space sampling sequence, the first space sampling sequence is any of the at least one space sampling sequence, the category input feature is obtained by performing position encoding merging on a category feature, and the category feature is used to characterize the plurality of action categories; and inputting the plurality of second image input features and the category input feature into the self-attention coding layer, and determining an output feature output by the self-attention coding layer corresponding to the category input feature as a space sequence sub-feature of the first space sampling sequence.

In some embodiments, the plurality of image frames are obtained based on image preprocessing, and the image preprocessing includes at least one operate of cropping, image enhancement or scaling.

In another aspect, a model training method is provided. The model training method includes: obtaining a plurality of sample image frames of a sample video, and a sample action category to which the sample video belongs; and performing self-attention training according to the plurality of sample image frames and the sample action category to obtain a trained self-attention model. The self-attention model is used to calculate similarity between a sample image feature sequence and a plurality of action categories, and the sample image feature sequence is obtained in time dimension or spatial dimension based on the plurality of sample image frames.

In some embodiments, before performing self-attention training according to the plurality of sample image frames and the sample action category to obtain the trained self-attention model, the method further includes: segmenting each sample image frame in the plurality of sample image frames to obtain a plurality of sampling sample sub-images. The self-attention model includes a self-attention coding layer and a classification layer. performing self-attention training according to the plurality of sample image frames and the sample action category to obtain the trained self-attention model, includes: determining at least one sample sequence feature of the sample video according to the plurality of sampling sample sub-images and the self-attention coding layer, the at least one sample sequence feature including a sample time sequence feature, or both the sample time sequence feature and a sample space sequence feature; and determining a sample similarity feature according to the at least one sample sequence feature of the sample video, the sample similarity feature being used to characterize similarity between the sample video and the plurality of action categories.

In some embodiments, determining the sample time sequence feature of the sample video according to the plurality of sampling sample sub-images and the self-attention coding layer, includes: determining at least one sample time sampling sequence from the plurality of sampling sample sub-images; determining a sample time sequence sub-feature of each sample time sampling sequence according to each sample time sampling sequence and the self-attention coding layer; and determining the sample time sequence feature of the sample video according to a sample time sequence sub-feature of the at least one sample time sampling sequence.

In some embodiments, determining the sample space sequence feature of the is sample video according to the plurality of sampling sample sub-images and the self-attention coding layer, includes: determining at least one sample space sampling sequence from the plurality of sampling sample sub-images; determining a sample space sequence sub-feature of each sample space sampling sequence according to each sample space sampling sequence and the self-attention coding layer; and determining the sample space sequence feature of the sample video according to a sample space sequence sub-feature of the at least one sample space sampling sequence.

In some embodiments, the plurality of sample image frames are obtained based on image preprocessing, and the image preprocessing includes at least one operate of cropping, image enhancement or scaling.

In yet another aspect, an action recognition device is provided. The action recognition device includes an obtaining unit and a determining unit. The obtaining unit is used to obtain a plurality of image frames of a video to be recognized. The determining unit is used to, after the obtaining unit obtains the plurality of image frames, determine a probability distribution of the video to be recognized being similar to a plurality of action categories according to the plurality of image frames and a pre-trained self-attention model. The self-attention model is used to calculate similarity between an image feature sequence and the plurality of action categories through a self-attention mechanism; the image feature sequence is obtained in time dimension or spatial dimension based on the plurality of image frames; and the probability distribution includes a probability that the video to be recognized is similar to each action category in the action categories. The determining unit is further used to determine a target action category corresponding to the video to be recognized based on the probability distribution of the video to be recognized being similar to the plurality of action categories. A probability that the video to be recognized is similar to the target action category is greater than or equal to a preset threshold.

In some embodiments, the self-attention model includes a self-attention coding layer and a classification layer, the self-attention coding layer is used to calculate a similarity feature of the image feature sequence relative to the plurality of action categories, and the classification layer is used to calculate the probability distribution corresponding to the similarity feature. The determining unit is used to: determine a target similarity feature of the video to be recognized relative to the plurality of action categories according to the plurality of image frames and the self-attention coding layer, the target similarity feature being used to characterize similarity between the video to be recognized and each action category; and input the target similarity feature to the classification layer to obtain the probability distribution of the video to be recognized being similar to the plurality of action categories.

In some embodiments, the action recognition device further includes a processing unit. The processing unit is used to, before the determining unit determines the target similarity feature of the video to be recognized relative to the plurality of action categories according to the plurality of image frames and the self-attention coding layer, segment each image frame in the plurality of image frames to obtain a plurality of sampling sub-images. The determining unit is used to determine sequence feature(s) of the video to be recognized according to the plurality of sampling sub-images and the self-attention coding layer, and determine the target similarity feature according to the sequence feature(s) of the video to be recognized. The sequence feature(s) include a time sequence feature, or both the time sequence feature and a space sequence feature. The time sequence feature is used to characterize similarity between the video to be recognized and the plurality of action categories in the time dimension, and the space sequence feature is used to characterize similarity between the video to be recognized and the plurality of action categories in the spatial dimension.

In some embodiments, the determining unit is used to: determine at least one time sampling sequence from the plurality of sampling sub-images, each time sampling sequence including sampling sub-images of all image frames located in same positions; determine a time sequence sub-feature of each time sampling sequence according to each time sampling sequence and the self-attention coding layer, the time sequence sub-feature being used to characterize similarity between each time sampling sequence and the plurality of action categories; and determine the time sequence feature of the video to be recognized according to a time sequence sub-feature of the at least one time sampling sequence.

In some embodiments, the determining unit is used to: determine a plurality of first image input features and a category input feature, wherein each first image input feature is obtained by performing position encoding merging on image features of sampling sub-images included in a first time sampling sequence, the first time sampling sequence is any of the at least one time sampling sequence, the category input feature is obtained by performing position encoding merging on a category feature, and the category feature is used to characterize the plurality of action categories; and input the plurality of first image input features and the category input feature to the self-attention coding layer, and determine an output feature output by the self-attention coding layer corresponding to the category input feature as a time sequence sub-feature of the first time sampling sequence.

In some embodiments, the determining unit is used to: determine at least one space sampling sequence from the plurality of sampling sub-images, each space sampling sequence including sampling sub-images of an image frame; determine a space sequence sub-feature of each space sampling sequence according to each space sampling sequence and the self-attention coding layer, the space sequence sub-feature being used to characterize similarity between each space sampling sequence and the plurality of action categories; and determine the space sequence feature of the video to be recognized according to a space sequence sub-feature of the at least one space sampling sequence.

In some embodiments, the determining unit is used to: for a first image frame, determine a preset number of target sampling sub-images located in preset positions from sampling sub-images included in the first image frame, and determine the target sampling sub-images as a space sampling sequence corresponding to the first image frame. The first image frame is any of the plurality of image frames.

In some embodiments, the determining unit is used to: determine a plurality of second image input features and a category input feature, wherein each second image input feature is obtained by performing position encoding merging on image features of sampling sub-images included in a first space sampling sequence, the first space sampling sequence is any of the at least one space sampling sequence, the category input feature is obtained by performing position encoding merging on a category feature, and the category feature is used to characterize the plurality of action categories; and input the plurality of second image input features and the category input feature to the self-attention coding layer, and determine an output feature output by the self-attention coding layer corresponding to the category input feature as a space sequence sub-feature of the first space sampling sequence.

In some embodiments, the plurality of image frames are obtained based on image preprocessing, and the image preprocessing includes at least one operate of cropping, image enhancement or scaling.

In yet another aspect, a model training device is provided. The model training device includes an obtaining unit and a training unit. The obtaining unit is used to obtain a plurality of sample image frames of a sample video, and a sample action category to which the sample video belongs. The training unit is used to, after the obtaining unit obtains the plurality of sample image frames and the sample action category, perform self-attention training according to the plurality of sample image frames and the sample action category to obtain a trained self-attention model. The self-attention model is used to calculate similarity between a sample image feature sequence and a plurality of action categories; and the sample image feature sequence is obtained in time dimension or spatial dimension based on the plurality of sample image frames.

In yet another aspect, an electronic device is provided. The electronic device includes: a processor, and a memory used for storing instructions executable by the processor. The processor is configured to execute the instructions to implement the action recognition method provided by the first aspect and any possible design method thereof, or the model training method provided by the second aspect and any possible design method thereof.

In yet another aspect, a non-transitory computer-readable storage medium is provided. The computer-readable storage medium has stored therein computer program instructions that, when run on a computer (e.g., the electronic device, the action recognition device or the model training device), cause the computer to perform the action recognition method or the model training method in any of the above embodiments.

In yet another aspect, a computer program product is provided. The computer program product includes computer program instructions that, when executed by a computer (e.g., the electronic device, the action recognition device or the model training device), cause the computer to perform the action recognition method or the model training method in any of the above embodiments.

In yet another aspect, a computer program is provided. When the computer program is executed by a computer (e.g., the electronic device, the action recognition device or the model training device), the computer program causes the computer to perform the action recognition method or the model training method in any of the above embodiments.

The technical solution provided by the present embodiments calculates the probability distribution of the video to be recognized being similar to the plurality of action categories based on the self-attention model, and can directly determine the target action category to which the video to be recognized belongs from the plurality of action categories. Compare with the related art, there is no need to provide a convolutional neural network (CNN), and thus a large number of calculations caused by the use of convolution operations are avoided, and ultimately the computing resources of the device may be saved.

In addition, since the image feature sequence is obtained in time dimension or spatial dimension based on the plurality of image frames, the image feature sequence can represent the time sequence of the plurality of image frames, or the time sequence and space sequence of the plurality of image frames. Thus, the similarity between the video to be recognized and each action category may be learned to a certain extent from the time dimension and spatial dimension of the plurality of image frames, so as to make the probability distribution obtained subsequent rather accurate.

### BRIEF DESCRIPTION OF THE DRAWINGS

In order to describe technical solutions in the present disclosure more clearly, accompanying drawings to be used in some embodiments of the present disclosure will be introduced briefly below. Obviously, the accompanying drawings to be described below are merely accompanying drawings of some embodiments of the present disclosure, and a person of ordinary skill in the art may obtain other drawings according to these drawings. In addition, the accompanying drawings to be described below may be regarded as schematic diagrams, but are not limitations on an actual size of a product, an actual process of a method and an actual timing of a signal to which the embodiments of the present disclosure relate.

FIG. 1 is a structural diagram of an action recognition system, in accordance with some embodiments;

FIG. 2 is a first flowchart of an action recognition method, in accordance with some embodiments;

FIG. 3 is a schematic diagram of a self-defined sampling, in accordance with some embodiments;

FIG. 4 is a second flowchart of an action recognition method, in accordance with some embodiments;

FIG. 5 is a first timing diagram of an action recognition method, in accordance with some embodiments;

FIG. 6 is a third flowchart of an action recognition method, in accordance with some embodiments;

FIG. 7 is a schematic diagram of an image segmentation process, in accordance with some embodiments;

FIG. 8 is a fourth flowchart of an action recognition method, in accordance with some embodiments;

FIG. 9 is a schematic diagram of a time sampling sequence, in accordance with some embodiments;

FIG. 10 is a fifth flowchart of an action recognition method, in accordance with some embodiments;

FIG. 11 is a timing diagram of determining a time sequence feature, in accordance with some embodiments;

FIG. 12 is a sixth flowchart of an action recognition method, in accordance with some embodiments;

FIG. 13 is a schematic diagram of a space sampling sequence, in accordance with some embodiments;

FIG. 14 is a seventh flowchart of an action recognition method, in accordance with some embodiments;

FIG. 15 is a second timing diagram of an action recognition method, in accordance with some embodiments;

FIG. 16 is a flowchart of a model training method, in accordance with some embodiments;

FIG. 17 is a structural diagram of an action recognition device, in accordance with some embodiments;

FIG. 18 is a structural diagram of a model training device, in accordance with some embodiments; and

FIG. 19 is a structural diagram of an electronic device, in accordance with some embodiments.

### DETAILED DESCRIPTION

Technical solutions in some embodiments of the present disclosure will be described clearly and completely with reference to the accompanying drawings below. Obviously, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as open and inclusive, i.e., “including, but not limited to”. In the description of the specification, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics described herein may be included in any one or more embodiments or examples in any suitable manner.

Hereinafter, the terms such as “first” and “second” are used for descriptive purposes only, and are not to be construed as indicating or implying the relative importance or implicitly indicating the number of indicated technical features. Thus, features defined with “first” or “second” may explicitly or implicitly include one or more of the features. In the description of the embodiments of the present disclosure, the term “a plurality of” or “the plurality of” means two or more unless otherwise specified.

The phrase “at least one of A, B and C” has a same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

The phrase “applicable to” or “configured to” as used herein means an open and inclusive expression, which does not exclude devices that are applicable to or configured to perform additional tasks or steps.

In addition, the use of the phrase “based on” is meant to be open and inclusive, since a process, step, calculation or other action that is “based on” one or more of the stated conditions or values may, in practice, be based on additional conditions or values exceeding those stated.

In the following, inventive principles of an action recognition method and a model training method provided by the embodiments of the present disclosure are introduced.

In the related art, when an electronic device recognizes behavior and action in a video, an action recognition model is usually pre-trained based on a convolutional neural network (CNN). During training of the action recognition model, the electronic device can perform frame extraction processing on a sample video to obtain a plurality of sample image frames, and train a preset convolutional neural network based on the plurality of sample image frames and a label of an action category to which the sample video belongs to obtain the action recognition model. Subsequently, during use of the action recognition model, the electronic device performs frame extraction processing on a video to be recognized to obtain a plurality of image frames, and inputs image features of the plurality of image frames into the action recognition model. Correspondingly, the action recognition model outputs an action category to which the video to be recognized belongs.

During training and use of the above action recognition model, in order to learn the features of the input image frames, a large number of convolution operations based on CNN are required, which will consume a large amount of device computing resources.

In some embodiments where the action recognition model is used, the related art further combines the action recognition model and an optical flow method to analyze the action category of the video, and optical flow images also need to be loaded in the CNN. Thus, there will also be a large number of convolution operations, resulting in consumption of a large amount of computing resources.

Considering that the convolution operations of CNN need to consume a large amount of computing, the embodiments of the present disclosure use a self-attention model to calculate similarity between a video to be recognized and a plurality of action categories, and determine probabilities that the video to be recognized is similar to the is plurality of action categories based on the determined similarity, and further determine an action category to which the video to be recognized belongs. Since using the self-attention model only needs an encoder therein, there is no need for convolution operations, and thus a large amount of computing resources can be saved.

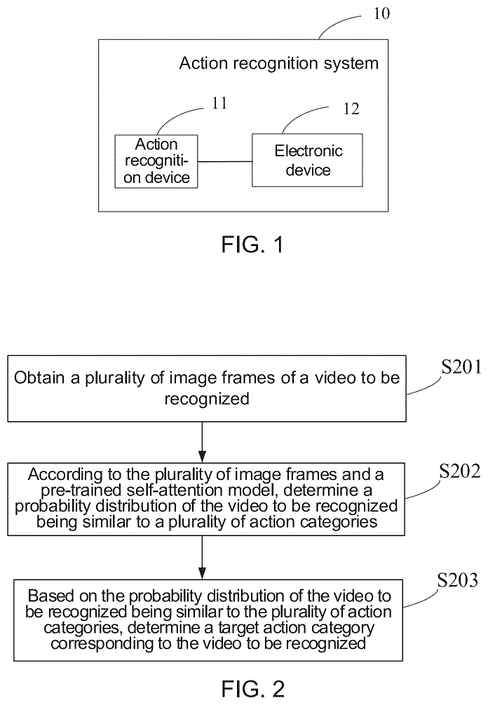

An action recognition method provided by some embodiments of the present disclosure may be applicable to an action recognition system. FIG. 1 shows a structural schematic diagram of the action recognition system. As shown in FIG. 1, the action recognition system 10 is used to solve a problem in the related art that performing action recognition on a video consumes a large amount of computing resources. The action recognition system 10 includes an action recognition device 11 and an electronic device 12. The action recognition device 11 is connected to the electronic device 12. The action recognition device 11 and the electronic device 12 may be connected in a wired manner or in a wireless manner, which is not limited in the embodiments of the present disclosure.

The action recognition device 11 may be used for data interaction with the electronic device 12. For example, the action recognition device 11 may obtain a video to be recognized and a sample video from the electronic device 12.

Moreover, the action recognition device 11 may also execute a model training method provided by the embodiments of the present disclosure. For example, the action recognition device 11 uses the sample video as a sample to train an action recognition model based on the self-attention mechanism, so as to obtain a trained self-attention model.

It will be noted that in some embodiments, in a case where the action recognition device is used to train the self-attention model, the action recognition device may also be called a model training device.

In addition, the action recognition device 11 may also execute the action recognition method provided by the embodiments of the present disclosure. For example, the action recognition device 11 may also process a video to be recognized or input the video to be recognized into the self-attention model to determine a target action category corresponding to the video to be recognized.

It will be noted that the video to be recognized or the sample video involved in the embodiments of the present disclosure may be a video captured by a camera device in the electronic device, or a video received by the electronic device and sent by other similar devices. The plurality of action categories involved in the embodiments of the present disclosure may specifically include falling, climbing, catching up, and other categories. The action recognition system involved in the embodiments of the present disclosure may be specifically applicable to nursing places, stations, hospitals, supermarkets, and other public monitoring places, and may also be applicable to smart homes, augmented reality (AR)/virtual reality (VR) technology, video analysis and understanding, and other scenarios.

The action recognition device 11 and the electronic device 12 may be independent devices, or may be integrated into a same device, which is not specifically limited in the present disclosure.

When the action recognition device 11 and the electronic device 12 are integrated into the same device, a communication mode between the action recognition device 11 and the electronic device 12 is communication between internal modules of the device. In this case, the communication flow between the two is the same as “the communication flow between the action recognition device 11 and the electronic device 12 in a case where the action recognition device 11 and the electronic device 12 are independent of each other”.

The following embodiments provided by the present disclosure will take the action recognition device 11 and the electronic device 12 being independently disposed as an example for illustration.

In practical applications, the action recognition method provided by the embodiments of the present disclosure may be applied to the action recognition device, and can also be applied to the electronic device. The action recognition method provided by the embodiments of the present disclosure will be described with reference to the accompanying drawings below by considering an example where the action recognition method is applied to the electronic device.

As shown in FIG. 2, the action recognition method provided by the embodiments of the present disclosure includes the following S201 to S203.

In S201, the electronic device obtains a plurality of image frames of a video to be recognized.

As a possible implementation, the electronic device obtains the video to be recognized, performs decoding and frame extraction processing on the video to be recognized, and uses a plurality of sampling frames obtained through decoding and frame extraction processing as the plurality of image frames.

As another possible implementation, after obtaining the video to be recognized and performing decoding and frame extraction on the video to be recognized, the electronic device performs image preprocessing on a plurality of sampling frames obtained by frame extraction to obtain the plurality of image frames.

The image preprocessing includes at least one operation of cropping, image enhancement or scaling.

As a third possible implementation, after obtaining the video to be recognized, the electronic device may decode the video to be recognized to obtain a plurality of decoded frames, and performs the above image preprocessing on the plurality of decoded frames to obtain preprocessed decoded frames. Further, the electronic device performs frame extraction and random sampling on the preprocessed decoded frames to obtain the plurality of image frames.

It will be noted that in the above frame extraction and random sampling process, random noise and fuzzy processing may be added to expand samples of the preprocessed decoded frames. For example, the random noise may be Gaussian noise.

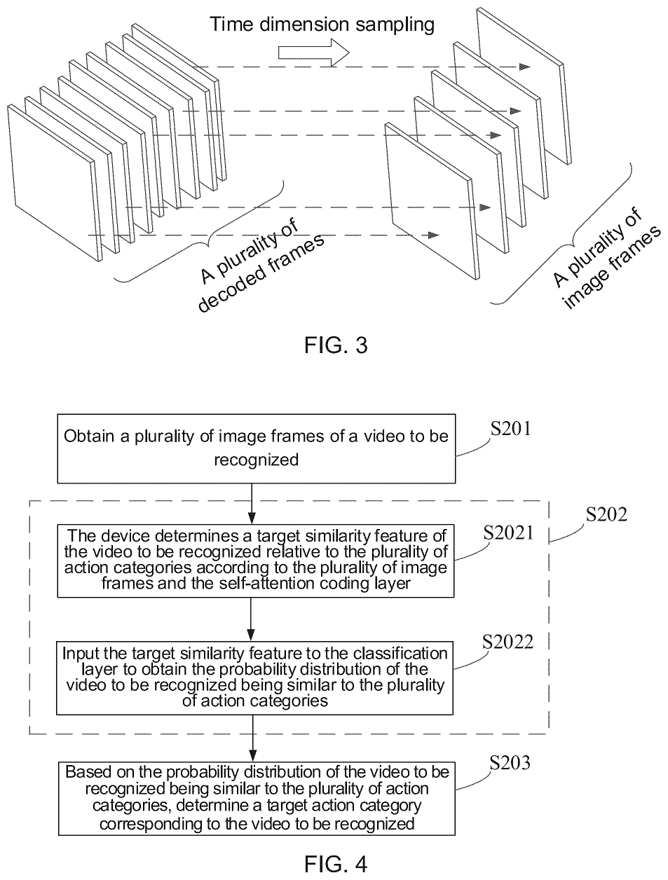

In addition, in the above sampling process, custom sampling in the time dimension, custom sampling in the spatial dimension, or a mixture custom sampling of the time dimension and the spatial dimension may be used. For example, FIG. 3 shows a sampling manner based on the custom sampling in the time dimension. As shown in FIG. 3, a plurality of decoded frames are obtained after the video to be recognized is decoded, and the electronic device may perform frame extraction and sampling on the plurality of decoded frames based on a custom sampling manner in the time dimension, so as to obtain the plurality of image frames.

It can be understood that by sampling in a variety of different sampling manners to obtain the image frames, it is possible to extract as much feature information as possible from the video to be recognized, so as to ensure accuracy of subsequent determining a target action category of the video to be recognized.

In some embodiments, the electronic device may also preset a preset sampling rate. In the above random sampling process, the plurality of decoded frames obtained by decoding or the preprocessed decoded frames may be sampled based on the preset sampling rate. For example, when the preset sampling rate is adopted, the number of the plurality of image frames may be 96 frames. In some embodiments, the preset sampling rate may be set to be greater than a sampling rate when using the CNN (convolutional neural network) is adopted.

Since the video to be recognized may have image distortion and protruding edges, the electronic device may crop each sampling frame based on a preset cropping size after obtaining the plurality of sampling frames and performing image preprocessing.

It will be noted that the above cropping may adopt a center cropping manner to crop out parts with severe distortion on a periphery of the sampling frame. For example, if the size of the sampling frame before cropping is 640×480, the preset cropping size is 256×256, and then a size of the image frame obtained by cropping each sampling frame is 256×256.

It can be understood that adopting the center cropping manner may reduce the influence of image distortion to a certain extent, and remove invalid feature information on a periphery of the sampling frame, which may make the subsequent self-attention model converge more easily and identify more accurately and faster.

Due to the different shooting conditions (from different environments and different lighting conditions) of the video to be recognized, when performing image preprocessing, the electronic device may perform image enhancement processing on the plurality of sampling frames.

It will be noted that the image enhancement operation includes brightness enhancement. When performing the image enhancement processing, a pre-packaged image enhancement function may be called to process each sampling frame.

It can be understood that the image enhancement processing may adjust brightness, color, contrast and other characteristics of each sampling frame, and can enhance corresponding generalization ability of each sampling frame.

In some cases, the self-attention model involved in the embodiments of the present disclosure has been trained in advance. Therefore, there are certain constraints on a pixel size of the image frame when inputting image features of the image frame. In this case, if the pixel sizes of the plurality of image frames obtained by sampling are different from the pixel size of the image frame constrained by the self-attention model, the electronic device needs to scale the obtained sampling frames to the pixel size to which the self-attention model can adapt. For example, the pixel size of the sample image frame used by the self-attention model in the training process is 256×256, and in the action recognition process, the pixel sizes of the plurality of image frames obtained by scaling can be 256×256.

In S202, the electronic device determines, according to the plurality of image frames and the pre-trained self-attention model, a probability distribution of the video to be recognized being similar to a plurality of action categories.

The self-attention model is used to calculate similarity between an image feature sequence and the plurality of action categories through a self-attention mechanism. The image feature sequence is obtained in time dimension or spatial dimension based on the plurality of image frames. The probability distribution includes a probability that the video to be recognized is similar to each action category in the action categories.

It will be noted that the self-attention model includes a self-attention coding layer and a classification layer. The self-attention coding layer is used to perform similarity calculation on the input feature sequence based on the self-attention mechanism, so as to calculate a similarity feature of each feature in the feature sequence relative to other features. The classification layer is used to perform similarity probability calculation on the similarity feature of each input feature relative to other features, so as to output the probability distribution of each feature being similar to other features.

As a possible implementation, the electronic device converts the plurality of image frames into the plurality of image features, and determines a sequence feature of the video to be recognized based on the plurality of converted image features and the self-attention coding layer. Further, the electronic device inputs the sequence feature of the video to be recognized into the classification layer, and then determines a plurality of probabilities output by the classification layer as the probability distribution of the video to be recognized being similar to the plurality of action categories.

In this case, the image feature sequence is generated in the time dimension or the spatial dimension according to the image feature of each image frame in the plurality of image frames.

The sequence feature of the video to be recognized is used to characterize the similarity between the video to be recognized and the plurality of action categories.

As another possible implementation, the electronic device performs segmentation processing on each image frame in the plurality of image frames to divide each image frame into sampling sub-images of preset sizes, and determines the sequence feature of the video to be recognized based on sampling sub-images included in the plurality of image frames. Further, the electronic device inputs the sequence feature of the video to be recognized into the classification layer, and then determines a plurality of probabilities output by the classification layer as the probability distribution of the video to be recognized being similar to the plurality of action categories.

In this case, the image feature sequence is generated in the time dimension or the spatial dimension according to the image feature of each sampling sub-image obtained by dividing each image frame in the plurality of image frames.

For the specific implementation of this step, reference may be made to the subsequent description of the embodiments of the present disclosure, which will not be provided here.

In S203, the electronic device determines a target action category corresponding to the video to be recognized based on the probability distribution of the video to be recognized being similar to the plurality of action categories.

The probability that the video to be recognized is similar to the target action category is greater than or equal to a preset threshold.

As a possible implementation, the electronic device determines an action category with the largest probability as a target action category from the probability distribution of the video to be recognized being similar to the plurality of action categories.

In this case, the preset threshold may be a maximum value of all probabilities in the determined probability distribution.

As another possible implementation, the electronic device determines an action category with a probability greater than the preset threshold as a target action category from the probability distribution of the video to be recognized being similar to the plurality of action categories.

The above technical solution provided by the embodiments of the present disclosure calculates the probability distribution of the video to be recognized being similar to the plurality of action categories based on the self-attention model, and can directly determine the target action category to which the video to be recognized belongs from the plurality of action categories. Compare with the related art, there is no need to provide the CNN, and thus a large number of calculations caused by the use of convolution operations are avoided, and ultimately the computing resources of the device may be saved.

In addition, since the image feature sequence is obtained in time dimension or spatial dimension based on the plurality of image frames, the image feature sequence can represent the time sequence of the plurality of image frames, or the time sequence and space sequence of the plurality of image frames. Thus, the similarity between the video to be recognized and each action category may be learned to a certain extent from the time dimension and spatial dimension of the plurality of image frames, so as to make the probability distribution obtained subsequent rather accurate.

In a design, in order to determine the probability distribution of the video to be recognized being similar to the plurality of action categories, the self-attention model provided by the embodiments of the present disclosure includes a self-attention coding layer and a classification layer. The self-attention coding layer is used to calculate a similarity feature of a sequence composed of a plurality of image features relative to the plurality of action categories, and the classification layer is used to calculate the probability distribution corresponding to the similarity feature.

In addition, as shown in FIG. 4, S202 provided by the embodiments of the present disclosure includes the following S2021 to S2022.

In S2021, the electronic device determines a target similarity feature of the video to be recognized relative to the plurality of action categories according to the plurality of image frames and the self-attention coding layer.

The target similarity feature is used to characterize the similarity between the video to be recognized and the plurality of action categories.

As a possible implementation, the electronic device performs feature extraction processing on the plurality of image frames to obtain image features of the plurality of image frames. For example, the image feature of each image frame may be expressed in a form of a vector, such as a vector with a length of 512 dimensions.

Further, the electronic device combines the image feature of each image frame with a corresponding position coding feature, so as to obtain a plurality of image input features of the self-attention coding layer.

It can be understood that in this case, a sequence composed of the plurality of image input features is the above image feature sequence.

It will be noted that each image feature corresponds to a position coding feature, and the position coding feature is used to identify a relative position of the corresponding image feature in the input sequence. The position coding feature may be pre-generated by the electronic device according to the image features of the plurality of image frames. For example, the position coding feature corresponding to the image feature may be a vector with 512 dimensions. In this case, the image input feature obtained by combining the image feature and the corresponding position coding feature is also a vector with a length of 512 dimensions.

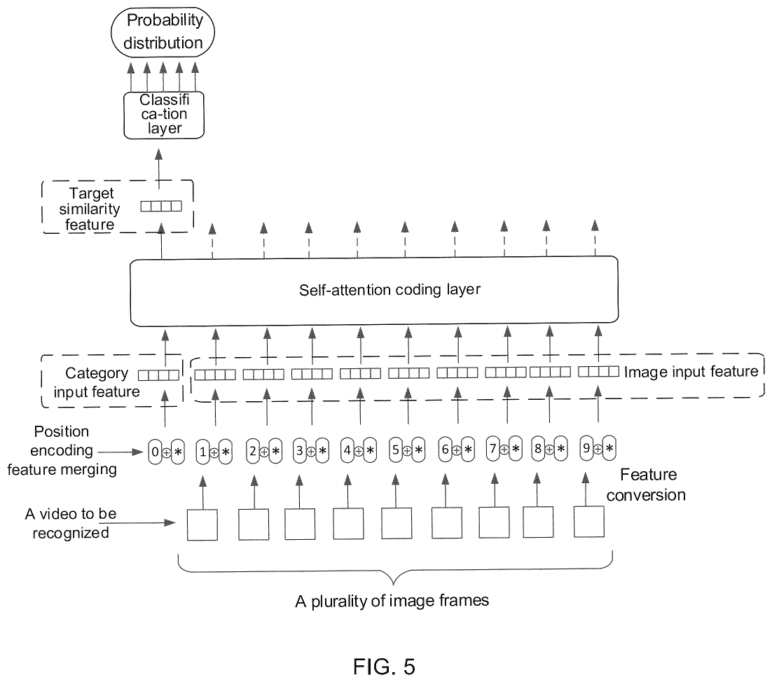

As an example, FIG. 5 shows a timing diagram of the action recognition method provided by some embodiments. As shown in FIG. 5, the number of the plurality of image frames is 9, and the electronic device converts the 9 image frames into 9 image features (corresponding to 0 to 9 in FIG. 5), and calculates to obtain 9 position coding features (corresponding to * in FIG. 5). Further, the electronic device combines the 9 image features with the 9 position coding features respectively to obtain an image feature sequence composed of 9 image input features (in this case, the image feature sequence is obtained based on the plurality of image frames in the time dimension). In the example in FIG. 5, the shape of the image feature sequence composed of the 9 image input features is (b, 9, 512), wherein b represents an image input feature, 9 represents the number of the image input features, and 512 represents a length of the image input feature.

In some cases, the position coding feature corresponding to the image frame may be learned automatically by the electronic device based on network, or may be determined based on a preset sin-cos rule. For the specific determination method of the position coding feature here, reference may be made to the description in the prior art, and details will not be repeated here.

Moreover, the electronic device obtains a learnable category feature (shown as a feature 0 in FIG. 5), and combines the category feature with a corresponding position coding feature to obtain a category input feature.

The category feature is used to characterize a feature of the plurality of action categories. The category feature may be preset in the self-attention coding layer. For example, the category feature may be a vector with a length of N dimensions, where N may be the number of the plurality of action categories.

It can be understood that the category input feature is obtained by combining the category feature and the corresponding position coding feature, and the category input feature is a feature used for being input to the self-attention coding layer.

Taking FIG. 5 as an example, after determining the category feature, the electronic device combines the category feature with the corresponding position coding feature to obtain a category input feature.

Subsequently, the electronic device inputs the image feature sequence composed of the category input feature and the plurality of image input features as a sequence to the self-attention coding layer, and uses a sequence feature output by the self-attention coding layer corresponding to the category input feature as a target similarity feature of the video to be recognized.

It can be understood that the sequence feature or the target similarity feature of the video to be recognized represents the similarity between the image features of the plurality of image frames and the plurality of action categories.

Taking FIG. 5 as an example, the electronic device uses the category input feature as the 0th feature, and uses 9 image input features as the 1st to 9th features (the image sequence feature), so as to form an input sequence to input into the self-attention coding layer. In this case, the shape of the composed input sequence is (b, 10, 512), where 10 is the number of features in the input sequence.

It will be noted that for input and output of the self-attention coding layer, taking FIG. 5 as an example, if the input sequence of the self-attention coding layer is (b, 10, 512), and then the output sequence thereof is also (b, 10, 512). In addition, the input sequence input to the self-attention coding layer includes 10 input features, and the output sequence thereof also includes 10 output features. The 10 input features are in one-to-one correspondence to the 10 output features. Each output feature reflects a weighted sum of similarity features of a corresponding input feature relative to other input features.

For the specific implementation of this step, reference may be made to subsequent similar specific descriptions of the present disclosure, and details are not provided here.

In some embodiments, the position of the category input feature in the input sequence may be the 0th position or any other position, and the difference lies in that the determined position coding features are different.

The above embodiments describe the implementation of directly using the plurality of image frames as the input features of the self-attention coding layer. As another possible implementation, the electronic device may also perform segmentation processing on each image frame, and determine the target similarity feature of the video to be recognized based on the sampling sub-images obtained by segmentation processing and the self-attention coding layer.

For the specific implementation of this step, reference may be made to the subsequent description of the embodiments of the present disclosure, which will not be provided here.

In S2022, the electronic device inputs the target similarity feature to the classification layer to obtain the probability distribution of the video to be recognized being similar to the plurality of action categories.

As a possible implementation, the electronic device inputs the target similarity feature of the video to be recognized to the classification layer of the self-attention model, so as obtain the probability distribution of the similarity between the video to be recognized and the plurality action categories output by the classification layer.

For example, the classification layer may be a multilayer perceptron (MLP) connected with the self-attention coding layer, and includes at least one fully connected layer and a logistic regression softmax layer, which is used to classify the input target similarity feature and calculate a probability distribution of each classification.

For the specific implementation of this step, reference may be made to the description in the prior art, and details are not repeated here.

As shown in FIG. 5, the electronic device inputs the target similarity feature into the classification layer, and the classification layer undergoes calculations of two fully connected layers and normalization operations of softmax to obtain and output the probability corresponding to each action category.

The specific implementation of the self-attention encoder involved in the embodiments of the present disclosure is separately introduced below.

After the category input feature and the plurality of image input features are input to the self-attention encoder, the self-attention encoder calculates the input features based on the self-attention mechanism to obtain an output result corresponding to each input feature. The output features corresponding to the category input features satisfy, under constraints of the self-attention mechanism, the following formula:

$$S = Attention ( Q , K , V ) = soft max ( \frac{{QK}^{T}}{\sqrt{d}} ) V .$$

S is an output feature corresponding to a category input feature, Q is a query conversion vector of the category input feature, K^{T} is transposition of a key conversion vector of the category input feature, V is a value conversion vector of the category input feature, and d is a dimension of the category input feature. For example, d may be 512.

In practical applications, the self-attention coding layer may adopt multi-headed self-attention mechanism or single-headed self-attention mechanism for processing.

It can be understood that the QK^{T} can be understood as a self-attention score in the self-attention coding layer, and softmax is a normalization process, i.e., converting the self-attention score after dimensionality reduction into a probability distribution. Further, a production of the probability distribution and V can be understood as a weighted sum of the probability distribution and V.

It will be noted that the self-attention mechanism can process the input category input feature, determine feature weights of the category input feature and the plurality of image input features, and convert the input category input feature based on a feature weight of the category input feature and each image input feature, so as to obtain the output feature corresponding to the category input feature. After the category input feature is processed by the self-attention mechanism, the corresponding output feature will introduce coding information of the plurality of image input features through the self-attention mechanism. For the processes of the electronic device performing query conversion, key conversion, and value conversion on different input features based on the self-attention mechanism, reference may be made to the prior art, and details are not provided here.

The above technical solution provided by the embodiments of the present disclosure can determine the similarity feature between the plurality of image frames and the plurality of action categories based on the self-attention mechanism by using the preset self-attention coding layer, and classify the similarity feature based on the classification layer to obtain the probability distribution of the video to be recognized belonging to the plurality of action categories. In this way, the implementation of determining the probability distribution of the video to be recognized belonging to the plurality of action categories is provided without using CNN, thereby saving the computing resources consumed by convolution operations.

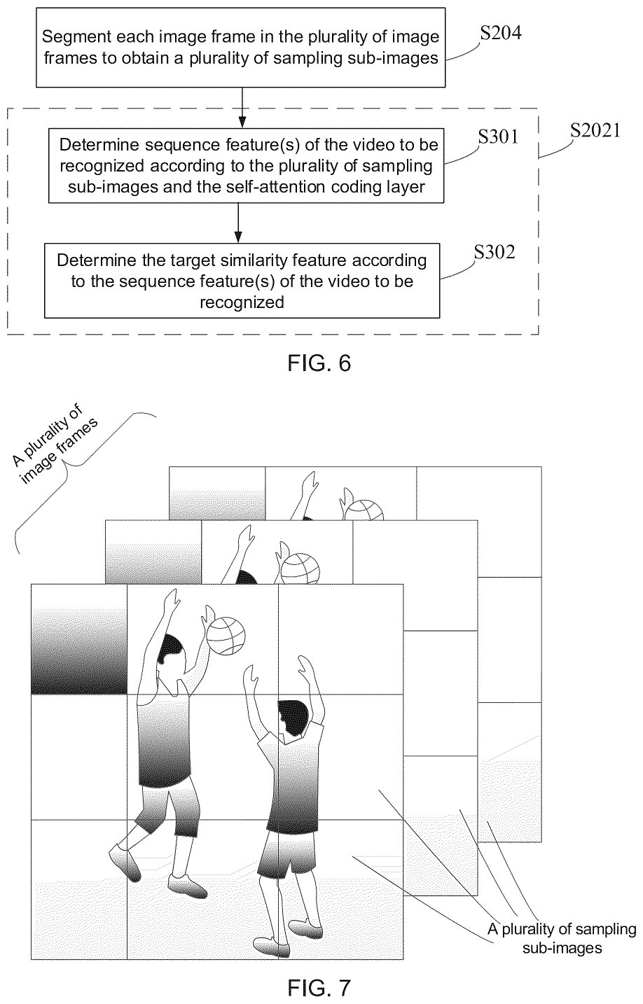

In a design, in order to learn more detailed features in the plurality of image frames of the video to be recognized, as shown in FIG. 6, the action recognition method provided by the embodiments of the present disclosure, before S2021, further includes the following S204.

In S204, the electronic device segments each image frame in the plurality of image frames to obtain a plurality of sampling sub-images.

As a possible implementation, the electronic device may perform segmentation processing on each image frame according to a preset segmentation pixel size to obtain the plurality of sampling sub-images.

The segmentation pixel size may be configured in advance in the electronic device by an operation and maintenance personnel of the action recognition system.

For example, in a case where a size of each image frame is 256×256 and the segmentation pixel size is 32×32, each image frame can be divided into 64 sampling sub-images. If there are 10 image frames of the video to be recognized, 640 sampling sub-images may be obtained after all the image frames are divided.

FIG. 7 is a schematic diagram of an image segmentation process. As shown in FIG. 7, for each image frame in the plurality of image frames, each image frame is may be divided into multiple sampling sub-images based on the size of each image frame and the segmentation pixel size.

In this case, as shown in FIG. 6, the S2021 provided by the embodiments of the present disclosure may include the following S301 to S302.

In S301, the electronic device determines sequence feature(s) of the video to be recognized according to the plurality of sampling sub-images and the self-attention coding layer.

The sequence feature(s) include a time sequence feature, or both the time sequence feature and space sequence features. The time sequence feature is used to characterize similarity between the video to be recognized and the plurality of action categories in the time dimension, and the space sequence feature is used to characterize similarity between the video to be recognized and the plurality of action categories in the spatial dimension.

As a possible implementation, the electronic device divides the plurality of sampling sub-images into a plurality of time sampling sequences according to the time sequence, and determines a time sequence sub-feature of each time sampling sequence according to each time sampling sequence and the self-attention coding layer. Further, the electronic device determines the time sequence feature of the video to be recognized according to a plurality of determined time sequence sub-features.

For the specific implementation of this step, reference may be made to the subsequent description of the embodiments of the present disclosure, which will not be provided here.

In addition, in a case where the sequence feature(s) include the time sequence feature and the space sequence feature, the electronic device further divides the plurality of sampling sub-images into a plurality of space sampling sequences according to the space sequence of image frames. Further, the electronic device determines a space sequence sub-feature of each space sampling sequence according to each space sampling sequence and the self-attention coding layer. Finally, the electronic device determines the space sequence feature of the video to be recognized according to a plurality of space sequence sub-features.

For the specific implementation of this step, reference may be made to the subsequent description of the embodiments of the present disclosure, which will not be provided here.

In S302, the electronic device determines the target similarity feature according to the sequence feature(s) of the video to be recognized.

In a case where the sequence feature(s) include the time sequence feature, the electronic device determines the determined time sequence feature of the video to be recognized as the target similarity feature of the video to be recognized.

In a case where the sequence feature(s) include both the time sequence feature and the space sequence feature, the electronic device combines the determined time sequence feature and space sequence feature, and determines the combined feature obtained by combination as the target similarity feature of the video to be recognized.

It will be noted that the above combined feature may also be obtained by fusing the time sequence feature and the space sequence feature based on other fusion methods, which is not limited in the embodiments of the present disclosure.

In the above technical solution provided by the embodiments of the present disclosure, each image frame is divided into multiple sampling sub-images of preset sizes, and according to the plurality of sampling sub-images, the time sequence feature is determined in the time dimension and the space sequence feature is determined in the spatial dimension. Thus, the target similarity feature determined in this way can reflect temporal feature and space feature of the video to be recognized, so that the target action category determined subsequently may be more accurate.

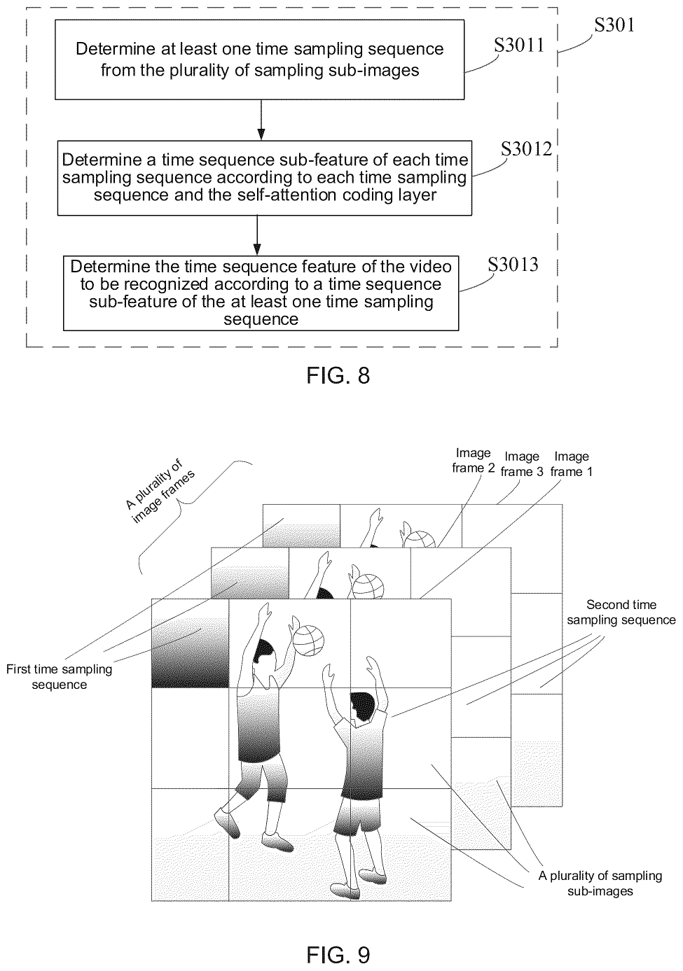

In a design, in order to determine the time sequence feature of the video to be recognized, as shown in FIG. 8, S301 provided by the embodiments of the present disclosure includes the following S3011 to S3013.

In S3011, the electronic device determines at least one time sampling sequence from the plurality of sampling sub-images.

Each time sampling sequence includes sampling sub-images of all image frames located in the same positions.

As a possible implementation, the electronic device divides the plurality of sampling sub-images into at least one time sampling sequence based on the time sequence.

It will be noted that the number of the time sampling sequence(s) is the number of the sampling sub-images obtained by dividing each image frame.

FIG. 9 shows a schematic diagram of a time sampling sequence. As shown in FIG. 9, the plurality of image frames include an image frame 1, an image frame 2 and an image frame 3, and each image frame includes 9 sampling sub-images. In the three image frames, a sampling sub-image at an upper left corner of each image frame may constitute a first time sampling sequence. For another example, a sampling sub-image at a middle right position of each image frame may constitute a second time sampling sequence.

In S3012, the electronic device determines a time sequence sub-feature of each time sampling sequence according to each time sampling sequence and the self-attention coding layer.

The time sequence sub-feature is used to characterize similarity between each time sampling sequence and the plurality of action categories.

As a possible implementation, for each time sampling sequence, the electronic device performs position encoding merging based on the image feature of each sampling sub-image to obtain the first image input feature (in combination with the above embodiments, a sequence composed of a plurality of first image input features corresponding to each time sampling sequence corresponds to the above image feature sequence, in this case, the image feature sequence is obtained from the plurality of image frames in the time dimension). Moreover, the electronic device further performs position encoding merging according to a category feature to obtain a category input feature. Further, the electronic device inputs a sequence composed of the category input feature and all first image input features (the image feature sequence) to the self-attention coding layer, and determines a feature output by the self-attention coding layer corresponding to the category input feature as a time sequence sub-feature of the time sampling sequence.

For the specific implementation of this step, reference may be made to the subsequent description of the embodiments of the present disclosure, which will not be provided here.

In S3013, the electronic device determines the time sequence feature of the video to be recognized according to a time sequence sub-feature of the at least one time sampling sequence.

As a possible implementation, the electronic device combines the time sequence sub-feature of the at least one time sampling sequence, and determines the combined feature obtained by combination as the time sequence feature of the video to be recognized.

It will be noted that the above combined feature may also be obtained by fusing a plurality of time sequence sub-features based on other fusion methods, which is not limited in the embodiments of the present disclosure.

The above technical solution provided by the embodiments of the present disclosure at least bring about that the plurality of sampling sub-images are divided into at least one time sampling sequence, the time sequence sub-feature of each time sampling sequence is determined, and the time sequence feature of the video to be recognized is determined according to the plurality of time sequence sub-features.

Since the sampling sub-images in each time sampling sequence have the same position in different image frames, the determined time sequence feature is more comprehensive and accurate.

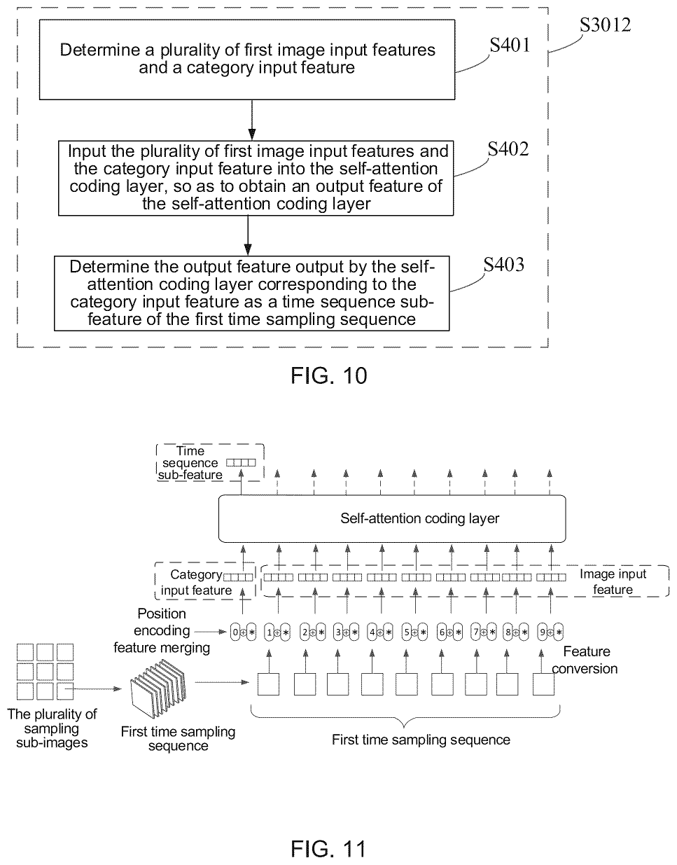

In a design, in order to determine the time sequence sub-feature of each time sampling sequence, as shown in FIG. 10, S3012 provided by the embodiments of the present disclosure includes the following S401 to S403.

In S401, the electronic device determines a plurality of first image input features and a category input feature.

Each first image input feature is obtained by performing position encoding merging on image features of sampling sub-images included in a first time sampling sequence, and the first time sampling sequence is any of the at least one time sampling sequence. The category input feature is obtained by performing position encoding merging on a category feature, and the category feature is used to characterize the plurality of action categories.

As a possible implementation, the electronic device determines an image feature of each sampling sub-image in the first time sampling sequence. Further, the electronic device combines the image feature of each sampling sub-image with a corresponding position coding feature to obtain a first image input feature corresponding to the image feature of each sampling sub-image.

Moreover, the electronic device further obtains a category feature corresponding to the plurality of action categories, and combines the category feature with a corresponding position coding feature to obtain the category input feature.

For the specific implementation of this step, reference may be made to the specific description of S2021 in the embodiments of the present disclosure, and details are not repeated here.

In S402, the electronic device inputs the plurality of first image input features and the category input feature into the self-attention coding layer, so as to obtain an output feature of the self-attention coding layer.

For the specific implementation of this step, reference may be made to the specific description of S2021 in the embodiments of the present disclosure, and details are not repeated here.

In S403, the electronic device determines the output feature output by the self-attention coding layer corresponding to the category input feature as a time sequence sub-feature of the first time sampling sequence.

As a possible implementation, the electronic device determines the output feature corresponding to the category input feature as the time sequence sub-feature of the first time sampling sequence.

FIG. 11 shows a timing diagram of determining time sequence features in the above embodiments. As shown in FIG. 11, for the first time sampling sequence, the electronic device converts the sampling sub-images included in the first time sampling sequence into 9 image features (0 to 9), and combines the 9 image features with the corresponding position coding features to obtain 9 image input features (corresponding to the image sequence feature obtained by the plurality of image frames based on the time dimension) corresponding to the first time sampling sequence. Further, the electronic device inputs the category input feature and the 9 image input features into the self-attention coding layer to obtain the output feature corresponding to the category input feature, and determines the output feature as the time sequence sub-feature of the first time sampling sequence.

The above technical solution provided by the embodiments of the present disclosure may determine the time sequence sub-feature of each time sampling sequence relative to the plurality of action categories by using the self-attention coding layer. Compared with the related art, there is no need for convolution operations, and thus corresponding computing resources can be saved.

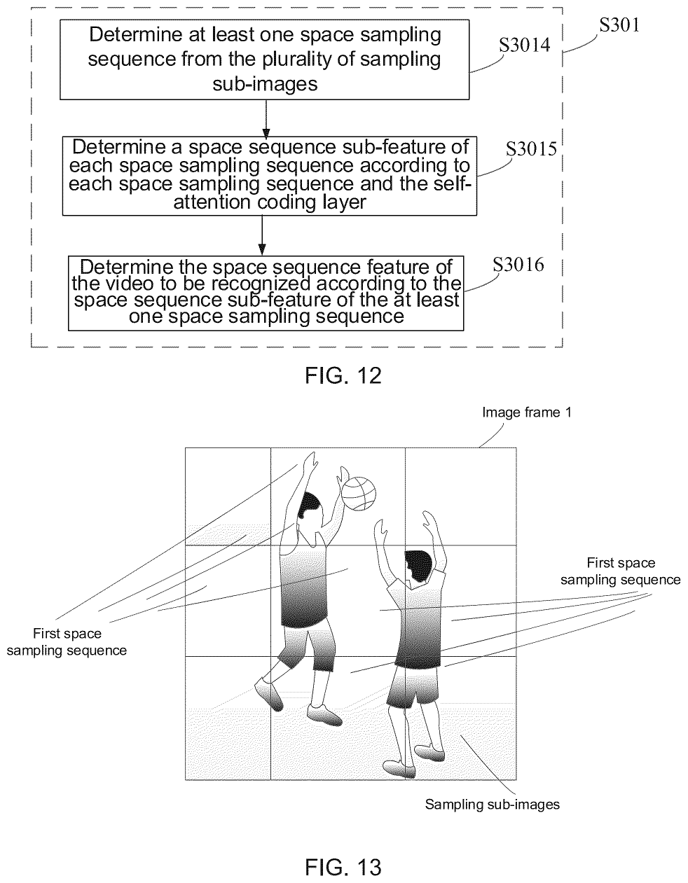

In a design, in a case where the sequence feature of the video to be recognized includes the time sequence feature and the space sequence feature, in order to determine the space sequence feature of the video to be recognized, as shown in FIG. 12, S301 provided by the embodiments of the present disclosure further includes the following S3014 to S3016.

In S3014, the electronic device determines at least one space sampling sequence from the plurality of sampling sub-images.

Each space sampling sequence includes sampling sub-images of an image frame.

As a possible implementation, the electronic device divides the plurality of sampling sub-images into at least one space sampling sequence based on the space sequence.

For example, the sampling sub-images included in an image frame may be determined as a space sampling sequence. In this case, the number of the at least one space sampling sequence is the same as the number of the plurality of image frames. For example, in FIG. 7, all sampling sub-images included in each image frame may be regarded as a space sampling sequence.

As another possible implementation, for a first image frame in the plurality of image frames, the electronic device may also determine a preset number of target sampling sub-images located in preset positions from sampling sub-images included in the first image frame, and determine the target sampling sub-images as the space sampling sequence corresponding to the first image frame.

The first image frame is any of the plurality of image frames.

For example, the target sampling sub-images in the first image frame may be any adjacent M sampling sub-images.

FIG. 13 shows a schematic diagram of a space sampling sequence. As shown in FIG. 13, in an image frame 1, sampling sub-images at adjacent preset positions may be set as a first space sampling sequence. For example, the first space sampling sequence may be 4 sampling sub-images at an upper left part of the image frame 1, or the first space sampling sequence may be 4 sampling sub-images at a lower right part of the image frame 1.

The above technical solution provided by the embodiments of the present disclosure may use the preset number of target sampling sub-images located in the preset positions to generate at least one space sequence feature during determining each space sampling sequence. In this way, it is possible to reduce the number of the sampling sub-images of each space sampling sequence without affecting the space sequence feature, thereby reducing the computing consumption of subsequent self-attention coding layer.

In S3015, the electronic device determines a space sequence sub-feature of each space sampling sequence according to each space sampling sequence and the self-attention coding layer.

The space sequence sub-feature is used to characterize similarity between each space sampling sequence and the plurality of action categories.

For the specific implementation of this step, reference may be made to the specific description of S3012, the difference lies in that the processing objects are different, and details are not repeated here.

In S3016, the electronic device determines the space sequence feature of the video to be recognized according to the space sequence sub-feature of the at least one space sampling sequence.

As a possible implementation, the electronic device combines the space sequence sub-feature of the at least one space sampling sequence, and determines the combined feature obtained by combination as the space sequence feature of the video to be recognized.

It will be noted that the above combined feature may also be obtained by fusing a plurality of space sequence sub-features based on other fusion methods, which is not limited in the embodiments of the present disclosure.

The above technical solution provided by the embodiments of the present disclosure divides the plurality of sampling sub-images into at least one space sampling sequence, determines the space sequence sub-feature of each space sampling sequence, and determines the space sequence feature of the video to be recognized according to the plurality of space sequence sub-features. In this way, the determined space sequence feature is more comprehensive and accurate.

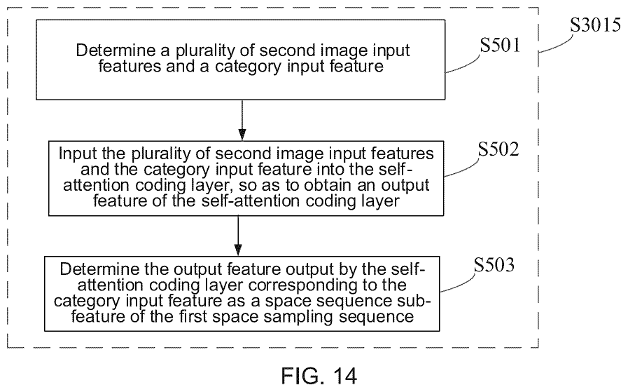

In a design, in order to determine the space sequence sub-feature of each space sampling sequence, as shown in FIG. 14, S3015 provided by the embodiments of the present disclosure includes the following S501 to S503.

In S501, the electronic device determines a plurality of second image input features and a category input feature.

Each second image input feature is obtained by performing position encoding merging on image features of sampling sub-images included in a first space sampling sequence, and the first space sampling sequence is any of the at least one space sampling sequence. The category input feature is obtained by performing position encoding merging on a category feature, and the category feature is used to characterize the plurality of action categories.

As a possible implementation, the electronic device determines an image feature of each sampling sub-image in the first space sampling sequence. Further, the electronic device combines the image feature of each sampling sub-image with a corresponding position coding feature to obtain a second image input feature corresponding to the image feature of each sampling sub-image (in some embodiments, a plurality of second image input features correspond to the image sequence feature in the above embodiments, in this case, the image feature sequence is obtained based on the plurality of image frames in the spatial dimension).

Moreover, the electronic device further obtains a category feature corresponding to the plurality of action categories, and combines the category feature with a corresponding position coding feature to obtain the category input feature.

For the specific implementation of this step, reference may be made to the specific description of S2021 in the embodiments of the present disclosure, and details are not repeated here.

In S502, the electronic device inputs the plurality of second image input features and the category input feature into the self-attention coding layer, so as to obtain an output feature of the self-attention coding layer.

For the specific implementation of this step, reference may be made to the specific description of S2021 in the embodiments of the present disclosure, and details are not repeated here.

In S503, the electronic device determines the output feature output by the self-attention coding layer corresponding to the category input feature as a space sequence sub-feature of the first space sampling sequence.

As a possible implementation, the electronic device determines the output feature corresponding to the category input feature as the space sequence sub-feature of the first space sampling sequence.

The above technical solution provided by the embodiments of the present disclosure may determine the space sequence sub-feature of each space sampling sequence relative to the plurality of action categories by using the self-attention coding layer, thereby avoiding the consumption of computing resources caused by the use of is convolution operations.

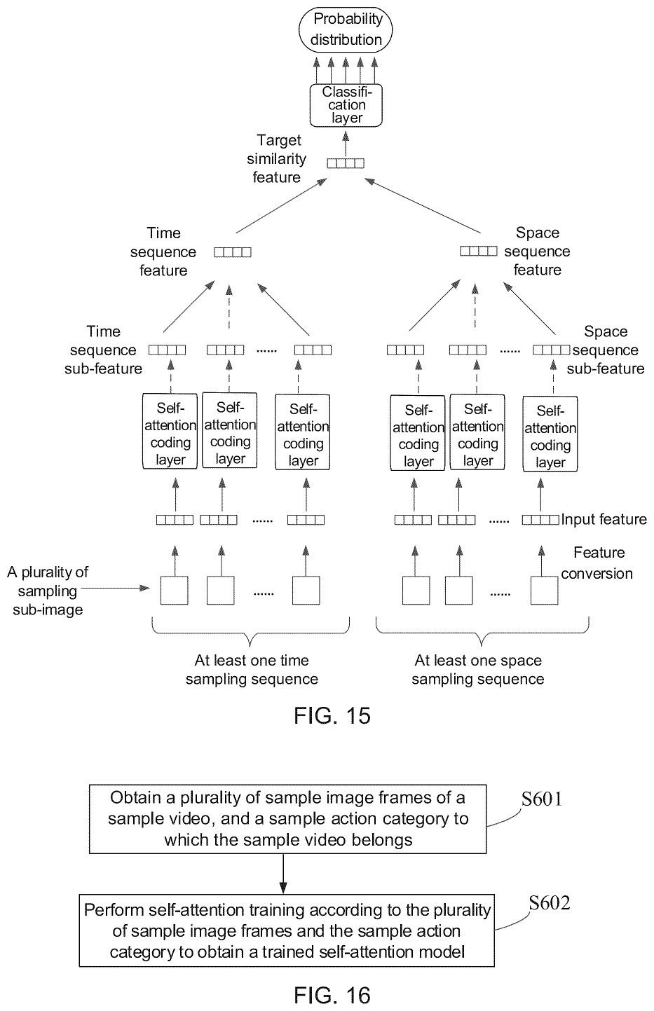

FIG. 15 shows a timing diagram of an action recognition method. As shown in FIG. 15, the electronic device performs segmentation processing on each image frame in the plurality of image frames to obtain the plurality of sampling sub-images. Further, the electronic device determines at least one time sampling sequence and at least one space sampling sequence from the plurality of sampling sub-images, determines a time sequence sub-feature of each time sampling sequence according to each time sampling sequence and the self-attention coding layer, and determines a space sequence sub-feature of each space sampling sequence according to each space sampling sequence and the self-attention coding layer. Subsequently, the electronic device combines a plurality of determined time sequence sub-features to obtain the time sequence feature of the video to be recognized, and the electronic device combines determined space sequence sub-features to obtain the space sequence feature of the video to be recognized. Further, the electronic device combines the time sequence feature of the video to be recognized and the space sequence feature of the video to be recognized to obtain the target similarity feature of the video to be recognized, and inputs the target similarity feature to the classification layer to determine the probability distribution of the video to be recognized being similar to the plurality of action categories.

In a design, in order to train the self-attention model provided by the embodiments of the present disclosure, the embodiments of the present disclosure further provide a model training method, and the model training method can also be applied to the above action recognition system.

In practical applications, the model training method provided by the embodiments of the present disclosure may be applied to the model training device, and may also be applied to electronic device. The following will describe the action recognition method provided by the embodiments of the present disclosure with reference to the accompanying drawings by considering an example where the model training method is applied to the electronic device.

As shown in FIG. 16, the model training method provided by the embodiments of the present disclosure includes the following S601 to S602.

In S601, the electronic device obtains a plurality of sample image frames of a sample video, and a sample action category to which the sample video belongs.

As a possible implementation, the electronic device obtains the sample video, performs decoding and frame extraction processing on the sample video, and uses a plurality of sampling frames obtained through decoding and frame extraction processing as the plurality of sample image frames.

As another possible implementation, after obtaining the sample video, the electronic device performs decoding and frame extraction on the sample video, and performs image preprocessing on a plurality of sampling frames obtained by frame extraction, so as to obtain a plurality of sample image frames.

The image preprocessing includes at least one operation of cropping, image enhancement or scaling.

As a third possible implementation, after obtaining the sample video, the electronic device may decode the sample video to obtain a plurality of decoded frames, and perform the above image preprocessing on the plurality of decoded frames to obtain preprocessed decoded frames. Further, the electronic device performs frame extraction and random sampling on the preprocessed decoded frames to obtain a plurality of sample image frames.

For the specific implementation of this step, reference may be made to the specific description of S201 in the embodiments of the present disclosure, the difference lies in that the processing objects are different, and details are not repeated here.

In S602, the electronic device performs self-attention training according to the plurality of sample image frames and the sample action category to obtain a trained self-attention model.

The self-attention model is used to calculate similarity between a sample image feature sequence and the plurality of action categories. The sample image feature sequence is obtained based on the plurality of sample image frames, and the sample image feature sequence is obtained in the time dimension or the spatial dimension based on the plurality of sample image frames.

As a possible implementation, the electronic device determines a sample similarity feature of the sample video based on the plurality of sample image frames and the self-attention coding layer, and trains a preset neural network by using the sample similarity feature as the sample feature and the sample action category as a label, so as to obtain a trained classification layer, and finally obtain the self-attention model by training.

The sample similarity feature is used to characterize the similarity between the sample video and the plurality of action categories.

In this case, an initial self-attention model includes the above self-attention coding layer and a preset neural network.

As another possible implementation, the electronic device may also use an initial self-attention model as a whole to perform self-attention training, and perform supervised training on input and output of a whole of the initial self-attention model by using the image features of the plurality of sample image frames as sample features and the sample action category of the sample video as a label, until the trained self-attention model is obtained by training.

As a third possible implementation, the electronic device may also use an initial self-attention model as a whole to perform self-attention training, divide each sample image frame in the plurality of sample image frames to obtain a plurality of sampling sample sub-images, and perform supervised training on the initial self-attention model based on the plurality of sampling sample sub-images, so as to obtain a trained self-attention model.

In the above process of using the initial self-attention model as a whole for training, gradient parameters to be adjusted in the initial self-attention model include parameters in the self-attention coding layer such as query, key and value, and weight parameters in the classification layer.

During adjusting parameters such as query, key, and value in the self-attention coding layer and the weight parameters in the classification layer, reference may be made to the prior art, and details are not provided here.

It will be noted that in the above process of performing iterative training on the neural network, a loss function of cross-entropy loss (ce loss) may be used for training.

For the specific steps of the electronic device determining the sample similarity feature of the sample video based on the plurality of sample image frames and the self-attention coding layer in this step, reference may be made to the specific description of the above S2021 in the embodiments of the present disclosure, the difference lies in that the processing objects are different, and details are not repeated here.

In the above technical solution provided by the embodiments of the present disclosure, the self-attention training is performed on the initial self-attention model based on the plurality of sample image frames of the sample video and the sample action category to which the sample video belongs to obtain the self-attention model. Since it is only necessary to determine the sample similarity feature of the plurality of sample image frames being similar to different sample action categories based on the self-attention mechanism during training, compared with the related art, there is no need to perform convolution operations based on CNN, thereby avoiding a large amount of computing caused by the use of convolution operation, and ultimately saving the computing resources of the device.

In a design, in order to determine the sample similarity feature of the sample video according to the plurality of sample image frames and the self-attention coding layer, the model training method provided by the embodiments of the present disclosure further includes the following S603.

In S603, the electronic device segments each sample image frame in the plurality of sample image frames to obtain a plurality of sampling sample sub-images.

For the specific implementation of this step, reference may be made to the specific description of S204 in the embodiments of the present disclosure, and details are not repeated here.

In this case, the above S602 provided by the embodiments of the present disclosure includes the following S6021 to S6022.

In S6021, the electronic device determines sample sequence feature(s) of the sample video according to the plurality of sampling sample sub-images and the self-attention coding layer.

The sample sequence feature(s) include a sample time sequence feature, or both the sample time sequence feature and a sample space sequence feature. The sample time sequence feature is used to characterize similarity between the sample video and the plurality of action categories in the time dimension, and the sample space sequence feature is used to characterize similarity between the sample video and the plurality of action categories in the spatial dimension.

For the specific implementation of this step, reference may be made to the specific description of S301 in the embodiments of the present disclosure, and details are not repeated here.

In S6022, the electronic device determines the sample similarity feature according to the sample sequence feature(s) of the sample video.

For the specific implementation of this step, reference may be made to the specific description of S302 in the embodiments of the present disclosure, and details are not repeated here.

In the above technical solution provided by the embodiments of the present disclosure, each sample image frame is divided into multiple sampling sample sub-images of preset sizes, and according to the multiple sampling sample sub-images, the sample time sequence feature is determined in the time dimension and the sample space sequence feature is determined in the spatial dimension. Thus, the sample similarity feature determined in this way can reflect temporal feature and space feature of the sample video, so that the self-attention model obtained by subsequent training may be more accurate.

In a design, in order to determine the time sample sequence feature of the sample video, S6021 provided by the embodiments of the present disclosure includes the following S701 to S703.

In S701, the electronic device determines at least one sample time sampling sequence from the plurality of sampling sample sub-images.

Each sample time sampling sequence includes sampling sample sub-images of all sample image frames located in the same positions.

For the specific implementation of this step, reference may be made to the specific description of S3011 in the embodiments of the present disclosure, the difference lies in that the processing objects are different, and details are not repeated here.

In S702, the electronic device determines, according to each sample time sampling sequence and the self-attention coding layer, a sample time sequence sub-feature of each sample time sampling sequence.

The sample time sequence sub-feature is used to characterize the similarity between each sample time sampling sequence and the plurality of action categories.

For the specific implementation of this step, reference may be made to the specific description of S3012 in the embodiments of the present disclosure, the difference lies in that the processing objects are different, and details are not repeated here.

In S703, the electronic device determines the sample time sequence feature of the sample video according to the sample time sequence sub-feature of the at least one sample time sampling sequence.

For the specific implementation of this step, reference may be made to the specific description of S3013 in the embodiments of the present disclosure, the difference lies in that the processing objects are different, and details are not repeated here.

The above technical solution provided by the embodiments of the present disclosure divides the plurality of sampling sample sub-images into at least one sample time sampling sequence, determines the sample time sequence sub-feature of each sample time sampling sequence, and determines the sample time sequence feature of the sample video according to a plurality of sample time sequence sub-features. Since the sampling sample sub-images in each sample time sampling sequence have the same position in different sample image frames, the determined sample time sequence feature is more comprehensive and accurate.

In a design, in order to determine the sample time sequence sub-feature of each sample time sampling sequence, S702 provided in the embodiments of the present disclosure includes the following S7021 to S7023.

In S7021, the electronic device determines a plurality of first sample image input features and a category input feature.

Each first sample image input feature is obtained by performing position encoding merging on image features of sampling sample sub-images included in the first sample time sampling sequence, and the first sample time sampling sequence is any of the at least one sample time sampling sequence. The category input feature is obtained by performing position encoding merging on a category feature, and the category feature is used to characterize the plurality of action categories.

In combination with the above embodiments, a sequence composed of the plurality of first sample image input features corresponds to the above sample image feature sequence. In this case, the sample image feature sequence is obtained according to the plurality of sample image frames in the time dimension.

For the specific implementation of this step, reference may be made to the specific description of S401 in the embodiments of the present disclosure, the difference lies in the processing objects are different, and details are not repeated here.

In S7022, the electronic device inputs the plurality of first sample image input features and the category input feature to the self-attention coding layer, so as to obtain an output feature of the self-attention coding layer.

For the specific implementation of this step, reference may be made to the specific description of S402 in the embodiments of the present disclosure, the difference lies in the processing objects are different, and details are not repeated here.

In S7023, the electronic device determines the output feature output by the self-attention coding layer corresponding to the category input feature as a sample time sequence sub-feature of the first sample time sampling sequence.

For the specific implementation of this step, reference may be made to the specific description of S403 in the embodiments of the present disclosure, the difference lies in the processing objects are different, and details are not repeated here.

The above technical solution provided by the embodiments of the present disclosure may determine the sample time sequence sub-feature of each sample time sampling sequence relative to the plurality of action categories by using the self-attention coding layer, thereby avoiding consumption of computing resources caused by the use of convolution operations.

In a design, in a case where the sample sequence feature(s) of the sample video include the sample time sequence feature and the sample space sequence feature, in order to determine the sample space sequence feature of the sample video, the above S6021 provided by the embodiments of the present disclosure includes the following S704 to S706.

In S704, the electronic device determines at least one sample space sampling sequence from the plurality of sampling sample sub-images.

Each sample space sampling sequence includes sampling sample sub-images in a sample image frame.

For the specific implementation of this step, reference may be made to the specific description of S3014 in the embodiments of the present disclosure, the difference lies in that the processing objects are different, and details are not repeated here.

In S705, the electronic device determines a sample space sequence sub-feature of each sample space sampling sequence according to each sample space sampling sequence and the self-attention coding layer.

The sample space sequence sub-feature is used to characterize the similarity between each sample space sampling sequence and the plurality of action categories.

For the specific implementation of this step, reference may be made to the specific description of S3015 in the embodiments of the present disclosure, the difference lies in that the processing objects are different, and details are not repeated here.

In S706, the electronic device determines the sample space sequence feature of the sample video according to the sample space sequence sub-feature of the at least one sample space sampling sequence.

For the specific implementation of this step, reference may be made to the specific description of S3016 in the embodiments of the present disclosure, the difference lies in that the processing objects are different, and details are not repeated here.

The above technical solution provided by the embodiments of the present disclosure divides the plurality of sampling sample sub-images into at least one sample space sampling sequence, determines the sample space sequence sub-feature of each sample space sampling sequence, and determines the sample space sequence feature of the sample video according to a plurality of sample space sequence sub-features. In this way, the determined sample space sequence feature is more comprehensive and accurate.

In a design, in order to determine the sample space sequence sub-feature of each sample space sampling sequence, S705 provided in the embodiments of the present disclosure includes the following S7051 to S7053.

In S7051, the electronic device determines a plurality of second sample image input features and a category input feature.

Each second sample image input feature is obtained by performing position encoding merging on image features of sampling sample sub-images included in the first sample space sampling sequence, and the first sample space sampling sequence is any of the at least one sample space sampling sequence. The category input feature is obtained by performing position encoding merging on a category feature, and the category feature is used to characterize the plurality of action categories.

In combination with the above embodiments, a sequence composed of the plurality of second sample image input features corresponds to the above sample image feature sequence. In this case, the sample image feature sequence is obtained according to the plurality of sample image frames in the space dimension.

For the specific implementation of this step, reference may be made to the specific description of S501 in the embodiments of the present disclosure, the difference lies in the processing objects are different, and details are not repeated here.

In S7052, the electronic device inputs the plurality of second sample image input features and the category input feature to the self-attention coding layer, so as to obtain an output feature of the self-attention coding layer.

For the specific implementation of this step, reference may be made to the specific description of S502 in the embodiments of the present disclosure, the difference lies in the processing objects are different, and details are not repeated here.

In S7053, the electronic device determines the output feature output by the self-attention coding layer corresponding to the category input feature as a sample space sequence sub-feature of the first sample space sampling sequence.

For the specific implementation of this step, reference may be made to the specific description of S503 in the embodiments of the present disclosure, the difference lies in the processing objects are different, and details are not repeated here.

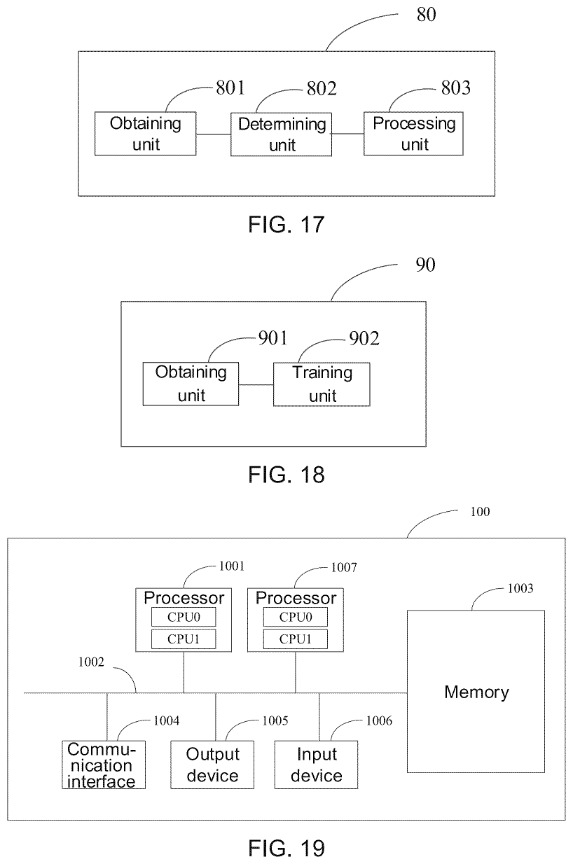

FIG. 17 is a structural schematic diagram of an action recognition device in accordance with an exemplary embodiment. Referring to FIG. 17, the action recognition device 80 provided by the embodiments of the present disclosure may be applied to the electronic device, and is used for performing the action recognition method provided by the above embodiments. The action recognition device 80 includes an obtaining unit 801 and a determining unit 802.

The obtaining unit 801 is used to obtain a plurality of image frames of a video to be recognized.

The determining unit 802 is used to, after the obtaining unit 801 obtains the plurality of image frames, determine a probability distribution of the video to be recognized being similar to a plurality of action categories according to the plurality of image frames and a pre-trained self-attention model. The self-attention model is used to calculate similarity between an image feature sequence and the plurality of action categories through a self-attention mechanism. The image feature sequence is obtained in time dimension or spatial dimension based on the plurality of image frames. The probability distribution includes a probability that the video to be recognized is similar to each action category in the plurality of action categories.

The determining unit 802 is further used to determine a target action category corresponding to the video to be recognized based on the probability distribution of the video to be recognized being similar to the plurality of action categories. A probability that the video to be recognized is similar to the target action category is greater than or equal to a preset threshold.

Optionally, as shown in FIG. 17, the self-attention model provided by the embodiments of the present disclosure includes a self-attention coding layer and a classification layer. The self-attention coding layer is used to calculate a similarity feature of the image feature sequence relative to the plurality of action categories, and the classification layer is used to calculate the probability distribution corresponding to the similarity feature. The determining unit 802 is further used to:

determine a target similarity feature of the video to be recognized relative to the plurality of action categories according to the plurality of image frames and the self-attention coding layer, the target similarity feature being used to characterize similarity between the video to be recognized and the plurality of action categories; and

input the target similarity feature to the classification layer to obtain the probability distribution of the video to be recognized being similar to the plurality of action categories.

Optionally, as shown in FIG. 17, the action recognition device 80 provided by the embodiments of the present disclosure further includes a processing unit 803.

The processing unit 803 is used to, before the determining unit 802 determines the target similarity feature of the video to be recognized relative to the plurality of action categories according to the plurality of image frames and the self-attention coding layer, segment each image frame in the plurality of image frames to obtain a plurality of sampling sub-images.

The determining unit 802 is further used to determine sequence feature(s) of the video to be recognized according to the plurality of sampling sub-images and the self-attention coding layer, and determine the target similarity feature according to the sequence feature(s) of the video to be recognized. The sequence feature(s) include a time sequence feature, or both the time sequence feature and a space sequence feature. The time sequence feature is used to characterize similarity between the video to be recognized and the plurality of action categories in the time dimension, and the space sequence feature is used to characterize similarity between the video to be recognized and each action category in the spatial dimension.

Optionally, as shown in FIG. 17, the determining unit 802 provided in the embodiments of the present disclosure is further used to:

determine at least one time sampling sequence from the plurality of sampling sub-images, each time sampling sequence including sampling sub-images of all image frames located in same positions;

determine a time sequence sub-feature of each time sampling sequence according to each time sampling sequence and the self-attention coding layer, the time sequence sub-feature being used to characterize similarity between each time sampling sequence and the plurality of action categories; and

determine the time sequence feature of the video to be recognized according to a time sequence sub-feature of the at least one time sampling sequence.

Optionally, as shown in FIG. 17, the determining unit 802 provided in the embodiments of the present disclosure is further used to:

determine a plurality of first image input features and a category input feature; each first image input feature being obtained by performing position encoding merging on image features of sampling sub-images included in a first time sampling sequence, the first time sampling sequence being any of the at least one time sampling sequence, the category input feature being obtained by performing position encoding merging on a category feature, and the category feature being used to characterize the plurality of action categories; and

input the plurality of first image input features and the category input feature to the self-attention coding layer, and determine an output feature output by the self-attention coding layer corresponding to the category input feature as a time sequence sub-feature of the first time sampling sequence.

Optionally, as shown in FIG. 17, the determining unit 802 provided in the embodiments of the present disclosure is further used to:

determine at least one space sampling sequence from the plurality of sampling sub-images, each space sampling sequence including sampling sub-images of an image frame;

determine a space sequence sub-feature of each space sampling sequence according to each space sampling sequence and the self-attention coding layer, the space sequence sub-feature being used to characterize similarity between each space sampling sequence and the plurality of action categories; and

determine the space sequence feature of the video to be recognized according to a space sequence sub-feature of the at least one space sampling sequence.

Optionally, as shown in FIG. 17, the determining unit 802 provided in the embodiments of the present disclosure is further used to:

for a first image frame, determine a preset number of target sampling sub-images located in preset positions from sampling sub-images included in the first image frame, and determine the target sampling sub-images as a space sampling sequence corresponding to the first image frame. The first image frame is any of the plurality of image frames.

Optionally, as shown in FIG. 17, the determining unit 802 provided in the embodiments of the present disclosure is further used to:

determine a plurality of second image input features and a category input feature, each second image input feature being obtained by performing position encoding merging on image features of sampling sub-images included in a first space sampling sequence, the first space sampling sequence being any of the at least one space sampling sequence, the category input feature being obtained by performing position encoding merging on a category feature, and the category feature being used to characterize the plurality of action categories; and

input the plurality of second image input features and the category input is feature to the self-attention coding layer, and determine an output feature output by the self-attention coding layer corresponding to the category input feature as a space sequence sub-feature of the first space sampling sequence.

Optionally, as shown in FIG. 17, the plurality of image frames provided by the embodiments of the present disclosure are obtained based on image preprocessing, and the image preprocessing includes at least one operate of cropping, image enhancement or scaling.

FIG. 18 is a structural schematic diagram of a model training device in accordance with an exemplary embodiment. Referring to FIG. 18, the model training device 90 provided by the embodiments of the present disclosure may be applied to the electronic device, and is used for performing the model training method provided by the above embodiments. The model training device 90 includes an obtaining unit 901 and a training unit 902.

The obtaining unit 901 is used to obtain a plurality of sample image frames of a sample video, and a sample action category to which the sample video belongs.

The training unit 902 is used to, after the obtaining unit 901 obtains the plurality of sample image frames and the sample action category, perform self-attention training according to the plurality of sample image frames and the sample action category to obtain a trained self-attention model. The self-attention model is used to calculate similarity between a sample image feature sequence and a plurality of action categories, and the sample image feature sequence is obtained in time dimension or spatial dimension based on the plurality of sample image frames.

Regarding the devices in the foregoing embodiments, the specific manner in which each module performs operations has been described in detail in the embodiments related to the method, and details are not repeated here.

FIG. 19 is a structural schematic diagram of an electronic device provided by the present disclosure. As shown in FIG. 19, the electronic device 100 may include at least one processor 1001 and a memory 1003 used for storing instructions executable by the processor. The processor 1001 is configured to execute the instructions in the memory 1003, so as to implement the action recognition method in the above embodiments.

In addition, the electronic device 100 may further include a communication bus 1002 and at least one communication interface 1004.

The processor 1001 may be a central processing unit (CPU), a microprocessor, an application-specific integrated circuit (ASIC), or one or more integrated circuits used for controlling execution of a program of solutions of the present disclosure.

The communication bus 1002 may include a communication path for transmitting information between the above components.

The communication interface 1004 uses any device of a transceiver and the like and is used for communicating with other devices or communication networks, such as Ethernet, radio access network (RAN), and wireless local area networks (WLAN).

The memory 1003 may be a read-only memory (ROM) or a static storage device of any other type that may store static information and instructions, a random access memory (RAM) or a dynamic storage device of any other type that may store information and instructions, or an electrically erasable programmable read-only memory (EEPROM), a compact disc read-only memory (CD-ROM) or any other compact disc storage or optical disc storage (including a compressed disc, a laser disc, an optical disc, a digital versatile disc or a Blu-ray disc), a magnetic disc storage medium or any other magnetic storage device, or any other medium that can be used to carry or store desired program codes in a form of instructions or data structures and that can be accessed by a computer, but it is not limited thereto. The memory may exist independently and is connected to a processing unit through a bus. The memory may also be integrated with the processing unit.

The memory 1003 is used to store instructions for execution of the solutions of the present disclosure, and the execution is controlled by the processor 1001. The processor 1001 is used to execute the instructions stored in the memory 1003, so as to implement the functions in the methods of the present disclosure.

As an example, with reference to FIG. 17, the functions implemented by the obtaining unit 801, the determining unit 802 and the processing unit 803 in the action recognition device are the same as the function of the processor 1001 in FIG. 19.

In a specific implementation, as an embodiment, the processor 1001 may include one or more CPUs, such as CPU0 and CPU1 shown in FIG. 19.

In a specific implementation, as an embodiment, the electronic device 100 may include a plurality of processors, such as a processor 1001 and a processor 1007 in FIG. 19. Each of these processors may be a single-CPU processor or a multi-CPU processor. The processor here may refer to one or more devices, circuits and/or processing cores for processing data (e.g., computer program instructions).

In a specific implementation, as an embodiment, the electronic device 100 may further include an output device 1005 and an input device 1006. The output device 1005 communicates with the processor 1001 and can display information in a variety of ways. For example, the output device 1005 may be a liquid crystal display (LCD), a light-emitting diode (LED) display device, a cathode ray tube (CRT) display device, a projector, or the like. The input device 1006 communicates with the processor 1001 and can accept input from an account in a variety of ways. For example, the input device 1006 may be a mouse, a keyboard, a touch screen device, or a sensing device.

Those skilled in the art can understand that the structure shown in FIG. 19 does not constitute a limitation to the electronic device 100, and may include more or less components compared with the components shown in the figure, or combine some components, or adopt different components.

Moreover, the structural schematic diagram of another hardware of the electronic device provided by the embodiments of the present disclosure may also refer to the description of the electronic device in FIG. 19, and details are not repeated here. The difference lies in that the processor included in the electronic device is used to perform steps in the model training method performed by the model training device in the above embodiments.

Some embodiments of the present disclosure provide a computer-readable storage medium (e.g., a non-transitory computer-readable storage medium). The computer-readable storage medium has stored therein computer program instructions that, when run on a computer (e.g., the electronic device), cause the computer to perform the action recognition method or the model training method in any of the above embodiments.

For example, the computer-readable storage medium may include, but is not limited to, a magnetic storage device (e.g., a hard disk, a floppy disk or a magnetic tape), an optical disk (e.g., a compact disk (CD), a digital versatile disk (DVD)), a smart card, a flash memory device (e.g., an erasable programmable read-only memory (EPROM), a card, a stick or a key driver). Various computer-readable storage media described in the present disclosure may represent one or more devices and/or other machine-readable storage media, which are used for storing information. The term “machine-readable storage media” may include, but be not limited to, wireless channels and various other media capable of storing, containing and/or carrying instructions and/or data.

Some embodiments of the present disclosure further provide a computer program product. For example, the computer program product is stored on in a non-transitory computer-readable storage medium. The computer program product includes computer program instructions that, when executed by a computer (e.g., the electronic device), cause the computer to perform the action recognition method or the model training method in any of the above embodiments.

Some embodiments of the present disclosure further provide a computer program that, when executed by a computer (e.g., the electronic device), causes the computer to perform the action recognition method or the model training method in any of the above embodiments.

Beneficial effects of the computer-readable storage medium, the computer program product, and the computer program are the same as the beneficial effects of the action recognition method or the model training method in any of some embodiments described above, and details are not be repeated here.

The foregoing descriptions are merely specific implementations of the present disclosure, but the protection scope of the present disclosure is not limited thereto. Changes or replacements that any person skilled in the art could conceive of within the technical scope of the present disclosure shall be included in the protection scope of the present disclosure. Therefore, the protection scope of the present disclosure shall be subject to the protection scope of the claims.

1. An action recognition method, comprising:
obtaining a plurality of image frames of a video to be recognized;
determining a probability distribution of the video to be recognized being similar to a plurality of action categories according to the plurality of image frames and a pre-trained self-attention model; wherein the self-attention model is used to calculate similarity between an image feature sequence and the plurality of action categories through a self-attention mechanism; the image feature sequence is obtained in time dimension or spatial dimension based on the plurality of image frames; and the probability distribution includes a probability that the video to be recognized is similar to each action category in the action categories; and
determining a target action category corresponding to the video to be recognized based on the probability distribution of the video to be recognized being similar to the plurality of action categories; wherein a probability that the video to be recognized is similar to the target action category is greater than or equal to a preset threshold.

2. The action recognition method according to claim 1, wherein the self-attention model includes a self-attention coding layer and a classification layer, the self-attention coding layer is used to calculate a similarity feature of the image feature sequence relative to the plurality of action categories, and the classification layer is used to calculate the probability distribution corresponding to the similarity feature; determining the probability distribution of the video to be recognized being similar to the plurality of action categories according to the plurality of image frames and the pre-trained self-attention model, includes:
determining a target similarity feature of the video to be recognized relative to the plurality of action categories according to the plurality of image frames and the self-attention coding layer; the target similarity feature being used to characterize similarity between the video to be recognized and each action category; and
inputting the target similarity feature to the classification layer to obtain the probability distribution of the video to be recognized being similar to the plurality of action categories.

3. The action recognition method according to claim 2, wherein before determining the target similarity feature of the video to be recognized relative to the plurality of action categories according to the plurality of image frames and the self-attention coding layer, the method further includes:
segmenting each image frame in the plurality of image frames to obtain a plurality of sampling sub-images; and
determining the target similarity feature of the video to be recognized relative to the plurality of action categories according to the plurality of image frames and the self-attention coding layer, includes:
determining at least one sequence feature of the video to be recognized according to the plurality of sampling sub-images and the self-attention coding layer, and determining the target similarity feature according to the at least one sequence feature of the video to be recognized; wherein
the at least one sequence feature includes a time sequence feature, or both the time sequence feature and a space sequence feature; the time sequence feature is used to characterize similarity between the video to be recognized and the plurality of action categories in the time dimension, and the space sequence feature is used to characterize similarity between the video to be recognized and the plurality of action categories in the spatial dimension.

4. The action recognition method according to claim 3, wherein determining the time sequence feature of the video to be recognized, includes:
determining at least one time sampling sequence from the plurality of sampling sub-images; each time sampling sequence including sampling sub-images of all image frames located in same positions;
determining a time sequence sub-feature of each time sampling sequence according to each time sampling sequence and the self-attention coding layer; the time sequence sub-feature being used to characterize similarity between each time sampling sequence and the plurality of action categories; and
determining the time sequence feature of the video to be recognized according to a time sequence sub-feature of the at least one time sampling sequence.

5. The action recognition method according to claim 4, wherein determining the time sequence sub-feature of each time sampling sequence according to each time sampling sequence and the self-attention coding layer, includes:
determining a plurality of first image input features and a category input feature; wherein each first image input feature is obtained by performing position encoding merging on image features of sampling sub-images included in a first time sampling sequence, and the first time sampling sequence is any of the at least one time sampling sequence; the category input feature is obtained by performing position encoding merging on a category feature, and the category feature is used to characterize the plurality of action categories; and
inputting the plurality of first image input features and the category input feature into the self-attention coding layer, and determining an output feature output by the self-attention coding layer corresponding to the category input feature as a time sequence sub-feature of the first time sampling sequence.

6. The action recognition method according to claim 3, wherein determining the space sequence feature of the video to be recognized, includes:
determining at least one space sampling sequence from the plurality of sampling sub-images; each space sampling sequence including sampling sub-images of an image frame;
determining a space sequence sub-feature of each space sampling sequence according to each space sampling sequence and the self-attention coding layer; the space sequence sub-feature being used to characterize similarity between each space sampling sequence and the plurality of action categories; and
determining the space sequence feature of the video to be recognized according to a space sequence sub-feature of the at least one space sampling sequence.

7. The action recognition method according to claim 6, wherein determining the at least one space sampling sequence from the plurality of sampling sub-images, includes:
for a first image frame, determining a preset number of target sampling sub-images located in preset positions from sampling sub-images included in the first image frame, and determining the target sampling sub-images as a space sampling sequence corresponding to the first image frame; the first image frame being any of the plurality of image frames.

8. The action recognition method according to claim 6, wherein determining the space sequence sub-feature of each space sampling sequence according to each space sampling sequence and the self-attention coding layer, includes:
determining a plurality of second image input features and a category input feature; wherein each second image input feature is obtained by performing position encoding merging on image features of sampling sub-images included in a first space sampling sequence, and the first space sampling sequence is any of the at least one space sampling sequence; the category input feature is obtained by performing position encoding merging on a category feature, and the category feature is used to characterize the plurality of action categories; and
inputting the plurality of second image input features and the category input feature into the self-attention coding layer, and determining an output feature output by the self-attention coding layer corresponding to the category input feature as a space sequence sub-feature of the first space sampling sequence.

9. The action recognition method according to claim 1, wherein the plurality of image frames are obtained based on image preprocessing, and the image preprocessing includes at least one operate of cropping, image enhancement or scaling.

10. A model training method, comprising:
obtaining a plurality of sample image frames of a sample video, and a sample action category to which the sample video belongs; and
performing self-attention training according to the plurality of sample image frames and the sample action category to obtain a trained self-attention model; wherein the self-attention model is used to calculate similarity between a sample image feature sequence and a plurality of action categories; and the sample image feature sequence is obtained in time dimension or spatial dimension based on the plurality of sample image frames.

11-17. (canceled)

18. An electronic device, comprising a processor and a memory used for storing instructions executable by the processor, wherein the processor is configured to execute the instructions to cause the electronic device to implement the action recognition method according to claim 1.

19. A non-transitory computer-readable storage medium, when instructions in the computer-readable storage medium are executed by a processor of an electronic device, the instructions causing the electronic device to perform the action recognition method according to claim 1.

20. The model training method according to claim 10, wherein before performing self-attention training according to the plurality of sample image frames and the sample action category to obtain the trained self-attention model, the method further includes:
segmenting each sample image frame in the plurality of sample image frames to obtain a plurality of sampling sample sub-images; and
the self-attention model includes a self-attention coding layer and a classification layer; and performing self-attention training according to the plurality of sample image frames and the sample action category to obtain the trained self-attention model, includes:
determining at least one sample sequence feature of the sample video according to the plurality of sampling sample sub-images and the self-attention coding layer, the at least one sample sequence feature including a sample time sequence feature, or both the sample time sequence feature and a sample space sequence feature; and
determining a sample similarity feature according to the at least one sample sequence feature of the sample video, the sample similarity feature being used to characterize similarity between the sample video and the plurality of action categories.

21. The model training method according to claim 20, wherein determining the sample time sequence feature of the sample video according to the plurality of sampling sample sub-images and the self-attention coding layer, includes:
determining at least one sample time sampling sequence from the plurality of sampling sample sub-images;
determining a sample time sequence sub-feature of each sample time sampling sequence according to each sample time sampling sequence and the self-attention coding layer; and
determining the sample time sequence feature of the sample video according to a sample time sequence sub-feature of the at least one sample time sampling sequence.

22. The model training method according to claim 20, wherein determining the sample space sequence feature of the sample video according to the plurality of sampling sample sub-images and the self-attention coding layer, includes:
determining at least one sample space sampling sequence from the plurality of sampling sample sub-images;
determining a sample space sequence sub-feature of each sample space sampling sequence according to each sample space sampling sequence and the self-attention coding layer; and
determining the sample space sequence feature of the sample video according to a sample space sequence sub-feature of the at least one sample space sampling sequence.

23. The model training method according to claim 10, wherein the plurality of sample image frames are obtained based on image preprocessing, and the image preprocessing includes at least one operate of cropping, image enhancement or scaling.

24. An electronic device, comprising a processor and a memory used for storing instructions executable by the processor, wherein the processor is configured to execute the instructions to cause the electronic device to implement the model training method according to claim 10.

25. A non-transitory computer-readable storage medium, when instructions in the computer-readable storage medium are executed by a processor of an electronic device, the instructions causing the electronic device to perform the model training method according to claim 10.
